(19) United States
(12) Patent Application Publication
(10) Pub. No.: US 2023/0206607 A1
(43) Pub. Date: Jun. 29, 2023

(54) SYSTEMS AND METHODS FOR TRAINING ARTIFICIAL INTELLIGENCE MODELS USING 3D RENDERINGS

(71) Applicant: Cutting Edge AI, Herndon, VA (US)

(72) Inventors: Logan Dopp, Herndon, VA (US); Anton Vattay, Herndon, VA (US); Martin Kelly, Herndon, VA (US)

(73) Assignee: Cutting Edge AI, Herndon, VA (US)

(21) Appl. No.: 18/145,658

(22) Filed: Dec. 22, 2022

Related U.S. Application Data
(60) Provisional application No. 63/293,623, filed on Dec. 23, 2021.

(51) Int. Cl. G06V 10/774; G06T 15/10; G06V 10/74; G06V 10/776

(52) U.S. Cl. CPC G06V 10/774; G06T 15/10; G06V 10/761; G06V 10/776; G06T 2200/24

(57) ABSTRACT

The embodiments execute machine-learning architectures for training and managing machine-learning architectures for object recognition and other image processing operations. A computer receives image data (e.g., still images, videos) with imagery of a target object. The computer generates a rendering of a virtual environment containing a simulated obj ect representing the target object. The computer generates a simulated video recording containing a “fly around” of the simulated object. Using the simulated video recording, the computer generates simulated still images as snapshots of the simulated object at various angles. The computer trains the machine-learning architecture to recognize the target object by applying the machine-learning architecture on the simulated still images containing the simulated object.

### CROSS-REFERENCE TO RELATED APPLICATIONS

This application claims priority to U.S. Provisional Application No. 63/293,623, entitled “Systems and Methods for Training Artificial Intelligence Models Using 3D Renderings,” filed Dec. 23, 2021, which is incorporated by reference in its entirety.

### TECHNICAL FIELD

This application generally relates to systems and methods for managing, training, and deploying a machine learning architecture for processing image data.

### BACKGROUND

Machine-learning architectures often perform computer vision and object recognition on imagery of media data. The machine-learning architecture can be trained to recognize a particular object by collecting images of the object and applying the machine-learning architecture on the collected images. The machine-learning architecture is more robust and capable of recognizing the object from various different perspectives by training the machine-learning architecture on imagery from those various different perspectives. The machine-learning architecture also conventionally employs an image estimation function that estimates or backfills gaps in the sample of collected images, improving the machine-learning architecture’s capability to recognize the object despite limited training imagery for the object at a particular perspective.

Conventional approaches can often be less than ideal or altogether insufficient for training the machine-learning architecture for object recognition. The capability of the machine-learning architecture is limited to the images collected for the training dataset. The images frequently contain disparate examples of the target object; indeed, training the machine-learning architecture on disparate examples is often desirable. However, the image data and the disparate examples often include limitations on or variations of various aspects of the target object or background environments. For example, to train the machine-learning architecture to recognize a particular make, model, and year of a particular car, the image collection could include pictures from various angles and situated in a particular environment as well as pictures from the same or different angles of the car situated in a different environment. The collection may include dozens or hundreds of pictures of different color cars, which may have slight modifications from each other, and the points of view are limited to those angles shown in the pictures. In this example, the computing device applies the machine-learning architecture on the collection of images, where the computing device performs estimation operations as an attempt to backfill gaps or confusion in the image collection. The estimation operations may be insufficient or suboptimal for estimating aspects of the car due to, for example, variations in the light or limited samples. As such, the trained machine-learning architecture has limited capacity for recognizing the car when viewed at certain angles and/or when viewed in certain environmental circumstances.

What is therefore needed is an improved means for training machine-learning architectures for recognizing objects that is less sensitive or resistant to limitations or variations in the training dataset.

### SUMMARY

Disclosed herein are systems and methods capable of addressing the above-described shortcomings and may provide any number of additional or alternative benefits and advantages. Embodiments include a computing device that executes software routines for processing image data to prepare simulated data for improving training operations of one or more machine-learning architectures to perform object recognition and other image processing operations. The computing device receives input image data (e.g., still images, videos) in discrete files or in continuous media stream, where the input image data contains imagery of a particular object targeted for training the machine-learning architecture to recognize (sometimes referred to as a target object). The computing device generates simulated data comprising a three-dimensional rendering of a virtual environment containing a simulated object as a virtual representation of the target object situated in the virtual environment. The computing device then generates a video recording simulating a “fly over” or “fly around” of the simulated object within the virtual environment (sometimes referred to as a simulated video recording). Using the simulated video recording, the computing device generates still images (sometimes referred to simulated still images). The computing device may parse the simulated still images from frames of the simulated video recording or generate snapshots of frames of the simulated video recording. The simulated still images contain imagery of the simulated image, from many different perspective angles of the simulated object.

The computing device then applies the machine-learning architecture on the simulated still images to train the machine-learning architecture for object recognition. Unlike conventional approaches to training a machine-learning architecture for object recognition, which apply the machine-learning architecture directly on an image collection of the target object and estimate or backfill gaps in the collection of images, the embodiments described herein may generate simulated data (e.g., virtual environment, simulated object, simulated video recording, simulated still images) and apply the machine-learning architecture on the simulated data for training the machine-learning architecture for object recognition.

In an embodiment, a computer-implemented method comprises receiving, by a computer, input image data for a target object, the input image data including one or more visual representations of the input object at a plurality of angles of the target object; generating, by the computer, a three-dimensional rendering of a virtual environment including a simulated object representing the target object situated in the virtual environment; generating, by the computer, a plurality of simulated still images for the simulated object, the plurality of simulated still images including the simulated object at a plurality of angles of the simulated object; applying, by the computer, a machine-learning architecture on the plurality of simulated still images to generate a predicted object for each particular simulated still image; determining, by the computer, a level of error for the machine-learning architecture based upon the predicted object for each particular simulated still image and an expected object indicated by a training label associated with the particular still image; and in response to determining that the level of error fails to satisfy a training threshold: updating, by the computer, one or more parameters of the machine-learning architecture based upon the predicted object for each particular simulated still image and using an expected object associated with the particular still image.

In some embodiments, a system comprises a non-transitory machine-readable storage memory configured to store executable instructions; and a computer comprising a processor coupled to the storage memory and configured, when executing the instructions, to: receive input image data for a target object, the input image data including one or more visual representations of the input object at a plurality of angles of the target object; generate a three-dimensional rendering of a virtual environment including a simulated obj ect representing the target object situated in the virtual environment; generate a plurality of simulated still images for the simulated object, the plurality of simulated still images including the simulated object at a plurality of angles of the simulated object; apply a machine-learning architecture on the plurality of simulated still images to generate a predicted object for each particular simulated still image; determine a level of error for the machine-learning architecture based upon the predicted object for each particular simulated still image and an expected object indicated by a training label associated with the particular still image; and in response to determining that the level of error fails to satisfy a training threshold: update one or more parameters of the machine-learning architecture based upon the predicted object for each particular simulated still image and using an expected object associated with the particular still image.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIGS. 1A-1B illustrate components of a system for processing image data, according to an embodiment.

FIGS. 2A-2B show dataflow between components of a system performing image-processing operations, according to an embodiment.

FIG. 3 shows steps of a method for generating simulated image data for training an object recognition engine of a machine-learning architecture, according to an embodiment.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

The embodiments described herein include a client-server or cloud-based environment, whereby a particular computing device functions as a server that performs the various image-processing operations according to image inputs and instructions received from various client-side electronic devices (sometimes referred to as client devices), such as client computing devices or cameras. The client devices upload or otherwise transmit the image data to the server, which the server processes to train one or more machine-learning architectures or to perform object recognition for one or more objects in the image data. Embodiments, however, may vary the processes performed by the various devices. As an example, the client device need not perform any operations and simply send the image data the server. In another example, the client device and the server may perform some portion of the image processing operations described herein. As another example, the client device may perform most or all of the image processing operations described herein, and the server may simply store outputs of the client device or perform a minimal amount of operations. Moreover, in some embodiments, the client device may perform the operations described herein and need not include a server or any other computing device.

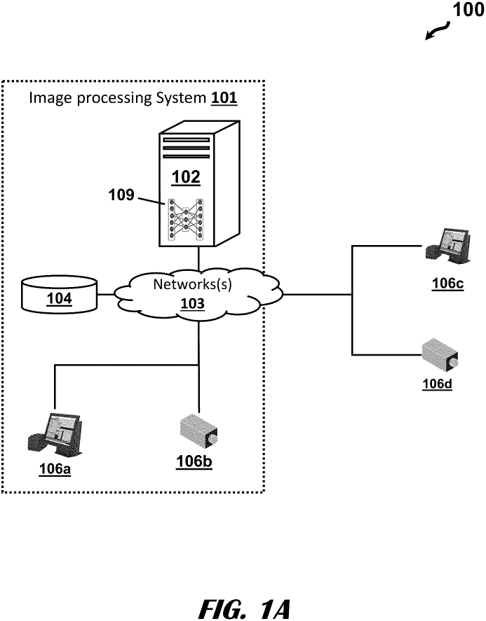

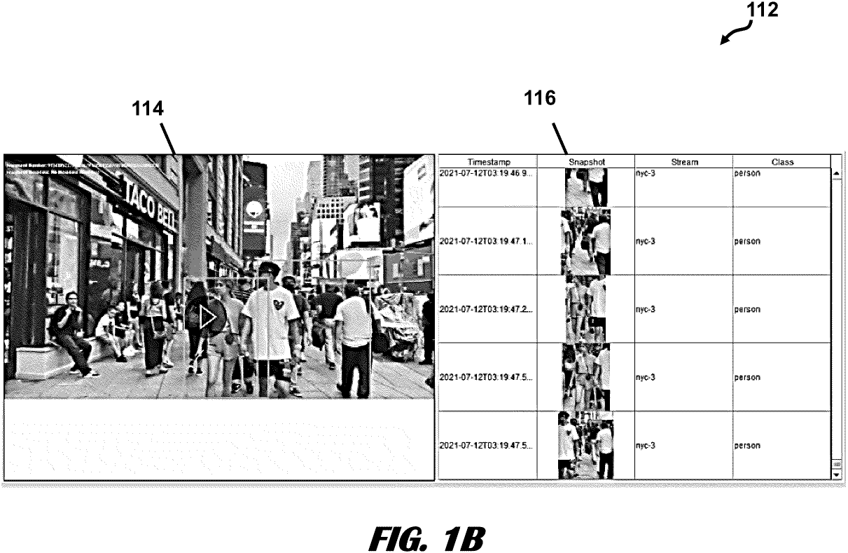

FIGS. 1A-1B illustrate components of a system 100 for processing image data, including one or more machine-learning architectures 109 for object recognition in various types of image data. The system 100 includes an image processing system 101 comprising image-processing servers 102 and databases 104. The system 100 includes various types of client computers 106a, 106c and cameras 106b, 106d (collectively referred to as client devices 106) that generate image data and transmit instructions for the image-processing server 102. The image processing system 101 represents an enterprise network infrastructure comprising physically and logically related software and electronic devices. The components of the system 100 and the image processing system 101 may communicate via one or more public or private networks 103 that host communication between internal devices (e.g., image-processing server 102, database 104, client computer 106a, client camera 106b) of the image processing system 101, and that host communication to and from external devices (e.g., client camera 106c, client camera 106d) outside of the enterprise infrastructure of the image processing system 101.

Embodiments may comprise additional or alternative components, or omit certain components, from those of FIGS. 1A-1B, and still fall within the scope of this disclosure. It may be common, for example, to include multiple image-processing servers 102. Embodiments may include or otherwise implement any number of devices capable of performing the various features and tasks described herein. For instance, FIG. 1A shows the image-processing server 102 as a distinct computing device from the database 104, though in some embodiments the image-processing server 102 includes an integrated database 104. In operation, the image-processing server 102 receives and processes input image data to generate simulations of objects, which the image-processing server 102 uses to generate training datasets for training the machine-learning architectures 109.

The system 100 comprises various hardware and software components of the one or more public or private networks 103 interconnecting the various components of the system 100. Non-limiting examples of such networks 103 may include Local Area Network (LAN), Wireless Local Area Network (WLAN), Metropolitan Area Network (MAN), Wide Area Network (WAN), and the Internet. The devices of the system 100 communicate over the networks 103 in accordance with various communication protocols, such as Transmission Control Protocol and Internet Protocol (TCP/IP), User Datagram Protocol (UDP), and IEEE communication protocols. Non-limiting examples of computing networking hardware may include switches, routers, among other additional or alternative hardware used for hosting, routing, and managing data communication via the Internet or other device communication medium.

As shown in FIG. 1A, in some embodiments the system 100 comprises the image processing system 101 as an enterprise computing infrastructure that includes the image-processing server 102, database 104, and internal client devices 106a, 106b. The components of the image processing system 101 communicate via a particular dedicated or private network 103. In such embodiments, the system 100 includes external client devices 106c, 106d communicate with the image-processing server 102 via an external-facing or public network 103, which comprises various hardware and software components similar to the dedicated network 103 that allows the external client devices 106c, 106d to communicate with the components of the image processing system 101. The internal client devices 106a, 106b access the image-processing server 102, via the dedicated or private network 103, to perform various administrative or management operations, such as uploading or entering the input image data for training the machine-learning architecture 109. The external client devices 106c, 106d access the image-processing services of the image processing system 101 and the image-processing server 102 via the external-facing or public network 103. For instance, an administrative user may use the client computer 106a to train the machine-learning architecture 109 by accessing the administrative functions of, and uploading the input image data to, the image-processing server 102 via the private or dedicated aspects of the network 103. The client camera 106b may similarly upload or stream input image data (e.g., video recordings, still images) to the image-processing server 102 via the network 103. Likewise, an external user may use the client computer 106c to upload input image data to the image-processing server 102 via the external-facing aspects of the network 103 and to transmit instructions for the image-processing server 102 to perform certain operations (e.g., object recognition operations). The camera 106d similarly uploads or streams input image data (e.g., video recordings, still images) to the image-processing server 102 via the public or external-facing network 103. Embodiments, however, need not include the image processing system 101 as a distinct computing infrastructure.

The image-processing server 102 includes one or more computing devices of the performing various operations for processing image data and performing object recognition, and updating, storing, and otherwise managing the machine-learning architectures 109. The image-processing server 102 includes any computing device comprising hardware (e.g., processors, non-transitory machine-readable memories) and software components and capable of performing the functions and processes described herein. The image-processing server 102 includes hardware (e.g., network interface card) and software for communicating via the one or more networks 103 with the client devices 106 and the database 104. Non-limiting examples of the image-processing server 102 includes servers, laptops, desktops, and the like. Although FIG. 1A shows only single image-processing server 102, the image-processing server 102 may include any number of computing devices. In some cases, the computing devices of the image-processing server 102 may perform all or sub-parts of the processes and benefits of the image-processing server 102. The image-processing server 102 may comprise computing devices operating in a distributed or cloud computing configuration and/or in a virtual machine configuration.

The image-processing server 102 receives the input image data in various formats or types of media data. The image-processing server 102 may receive the input image data as discrete machine-readable computer files or as a continuous data stream of media data. The input image data may include input video recordings 114, input still images 116, or a combination of input video recordings 114 and input still images 116. The image-processing server 102 receives the input image data from the various client devices 106, which may include any combination of the internal client computers 106a, external client computers 106b, internal cameras 106c, and external cameras 106d.

The image-processing server 102 receives and processes the input image data from the client devices 106 or from one or more internal or external databases 104 for training the machine-learning architectures 109. The image-processing server 102 may host or be in communication with the database 104, which contains various types of information that the image-processing server 102 references or queries when executing layers of the machine-learning architecture 109. The database 104 may store, for example, data records for known objects and trained models or layers of the machine-learning architecture 109, among other types of information.

The image-processing server 102 executes software for processing the input image data (e.g., computer files, continuous data stream). The input image data includes images displaying various types of objects. The image-processing server 102 processes the input image data and applies the machine-learning architecture 109 on the input image data to train an object recognition engine defined by layers of the machine-learning architecture 109. After training the object recognition engine, the trained machine-learning architecture 109 may receive and pre-process new input image data (e.g., from the external client computer 106c or camera 106d), and apply the object recognition engine on the new input image data to recognize one or more objects. The objects in the input image data may include any type of physical structure, a person’s face, or other visual feature (e.g., language of a banner or street sign). In some cases, the client computer 106a, 106c or image-processing server 102 executes design software (e.g., CAD software) allowing the user to design a particular target object. The design software generates a computer file containing the user-designed object, and the image-processing server 102 ingests the design computer file as the input image data from the design software.

To process the input image data and train the machine-learning architecture 109 to recognize a particular object, the software of the image-processing server 102 generates simulated image data using the input image data. The simulated data includes a three-dimensional rendering in a virtual environment that the image-processing server 102 generated using the input image data from one or more data sources. The input image data may include the input video recordings 114 or the input still images 116 from one or more data sources, which may include a corpus of image data stored in one or more databases 104 or inputs received from the client devices 106. The input image data includes the particular target object, where the input image may be any number of input video recordings 114 and/or input still images 116 from the same or disparate subjects, times, or events. For example, the input image data may include a variety of input video recordings 114 containing the target object from different times, locations, events, people, and/or objects. As another example, the target object may be a particular make, model, and year of a particular car to train the machine-learning architecture 109 to recognize the particular car. In this example, the input image data includes dozens or hundreds of input still images 116 displaying a variety of disparate photographs as examples of the particular car. The photographs show example instances of the particular car having disparate paint colors, background environments, perspective angles, and other visual aspects (e.g., dents, scratches, interiors). A user may use the client device 106 to select or upload the particular input image data containing the target object, or the image-processing server 102 may automatically determine the input image data according to data labels indicating the one or more objects displayed in the input image data. In some cases, where the input image data includes an input video recording 114, the image-processing server 102 performs various operations for parsing the input video recording 114 into any number of input still images 116 containing the target object. The image-processing server 102 generates the simulated data using the input still images 116.

The simulated data includes a simulated object that represents the target object situated within the computer-rendered virtual environment. The software of the image-processing server 102 performs certain operations for identifying the contours and texture of the target object within each of the input still images 116. The image-processing server 102 generates a simulated recording by shifting and rotating the virtual environment around the simulated object and in some cases zooming in to, and out from, the target object. The image-processing server 102 parses the simulated recording into any number of simulated still images displaying the simulated object. The image-processing server 102 then applies the machine-learning architecture 109 on the simulated still images to train the object recognition engine to recognize the particular target object in later image data.

The software executed by the image-processing server 102 includes the machine-learning architecture 109, which is organized as various types of machine-learning techniques and/or models, such as a Gaussian Mixture Matrix (GMM), neural network (e.g., convolutional neural network (CNN), deep neural network (DNN)), and the like. The machine-learning architecture 109 comprises executable functions or layers that perform the various image processing operations discussed herein. For example, the machine-learning architecture 109 includes functions and layers defining the object recognition engine, configured and trained for identifying (or recognizing) objects in input image data. In other examples, the machine-learning architecture 109 further includes layers and functions that define an object simulation engine for generating the simulated object in the virtual environment, a facial recognition engine, and/or a natural language processing engine, among others.

In some implementations, the machine-learning architecture 109 operates in several operational phases, including a training phase, an optional development phase, and a deployment phase (sometimes referred to as a “test phase” or “testing”). The image-processing server 102 performs certain operations and executes the machine-learning architecture 109 according to the operational phase. In operation, the image-processing server 102 or the machine-learning architecture 109 extracts image data features from the simulated data and applies the object recognition engine on the image data features to generate one or more outputs according to the operational phase. The image-processing server 102 may implement or feed the output to a downstream software operation or transmit the output the client device 106 or other device.

During the training phase, the image-processing server 102 trains the object recognition engine of the machine-learning architecture 109 to recognize various objects. The image-processing server 102 receives the input image data for the object targeted for training (i.e., target object) and generates simulated data including a simulated object representing the target object in a virtual environment. The image-processing server 102 applies the machine-learning architecture 109 on the simulated data having the simulated object to train the object recognition engine to recognize the target object. The image-processing server 102 may also train other aspects of the machine-learning architecture 109 using the input image data and/or simulated data. The image-processing server 102 may execute various optimization functions or algorithms, or receive various user inputs, for tuning the hyper-parameters or weights of the machine-learning architecture 109 based upon a level of error (or level of accuracy). When training, the machine-learning architecture 109 generates one or more predicted outputs (e.g., predicted object, predicted image features) and compares the predicated outputs against expected outputs (e.g., expected object, expected image features) as indicated by the labels associated with the simulated data (e.g., simulated still images). The image-processing server 102 determines the level of error based on the rate at which the image-processing server 102 correctly or incorrectly recognizes the target object in the same or different input image data having training labels. The image-processing server 102 stores the trained machine-learning architecture 109 into the database 104 when the level of error satisfies a threshold level of error.

In an optional development phase, the machine-learning architecture 109 may extract and store the image data features of known objects in the database 104 as known object features. In some embodiments, the machine-learning architecture 109 references the known object features during the later deployment phase. In the deployment phase, the machine-learning architecture 109 compares the known object features against the image data features that the machine-learning architecture 109 extracted from a later input image data containing a particular target object. The image-processing server 102 determines (or recognizes) that the target object is the known object when the distance or similarities between the image data features of the target object and the known object features of the known object satisfy a recognition threshold. During the deployment phase of other embodiments, the machine-learning architecture 109 implements any number of machine-learning techniques or functions for object recognition when applying the machine-learning architecture 109 that was trained using the simulated data.

The examples above are not limiting upon potential embodiments of the machine-learning architecture 109 as applied to the simulated data. For example, other embodiments may implement clustering, outlier detection, or other machine-learning techniques for extracting features from the image data (e.g., input image data, simulated data) and recognizing objects. Nor are approaches to training, optimizing, or tuning the machine-learning architecture 109 mentioned above limited to the examples described above. Embodiments may execute any number of machine-learning techniques and functions for training, optimizing, or tuning the machine-learning architecture 109 using the simulated data.

In some embodiments, the image-processing server 102 includes machine-executed software that executes the various operations according to inputs received from the client devices 106. For instance, in some embodiments, the image-processing server 102 executes webserver software (e.g., Microsoft IIS®, Apache HTTP Server®) or the like for hosting websites and web-based software applications. In such embodiments, the client devices 106 execute browser software for accessing and interacting with the website or other cloud-based features hosted and executed by the image-processing server 102. The users operate the client devices 106 to access the cloud-based features hosted by the image-processing server 102. The cloud-based features allow the users to, for example, upload or transmit the input image data to the image-processing server 102, access design software features to create the input image data, configure the image processing operations (e.g., configure renderings of virtual environments, submit instructions or training labels for training the machine-learning architectures 109), and submit requests for the image-processing server 102 to apply the trained machine-learning architectures 109, among any number of other features.

The system 100, as shown in FIG. 1A, comprises a single database 104 for ease of description. The system 100, however, may comprise any number of databases 104, which may internal or external to the image processing system 101 and may contain various types of data referenced by the components of the system 100 when performing certain operations. The database 104 may be hosted on any computing device (e.g., server, desktop computer) comprising hardware and software components capable of performing the various processes and tasks of the database 104 described herein, such as non-transitory machine-readable storage media and database management software (DBMS). The database 104 contains any number of corpora of training image data that are accessible to the image-processing server 102 via the one or more networks 103. The image-processing server 102 employs supervised training operations to train the machine-learning architectures 109, where the database 104 contains the trained aspects of the machine-learning architecture 109, input image data, and training labels, among other types of information. The labels indicate, for example, the expected outputs for the input image data used for training the machine-learning architecture 109.

The client devices 106 may be any computing devices or media devices that generate or transmit the input image data to the image-processing server 102, and/or access the image-processing features hosted by the image-processing server 102 or the image processing system 101. The client device 106 includes a hardware (e.g., processors) and software components and capable of performing the functions or processes described herein. The client devices 106 may include, for example, client computers 106a, 106c for interacting with the image-processing server 102, and client cameras 106b, 106d for generating image data (e.g., video recordings, still images) for the image-processing server 102. Non-limiting examples of the client computers 106a, 106c may include mobile devices, laptops, desktops, and servers, among other types of computing devices. The client device 106 may also include the hardware (e.g., network interface card) and software components for communicating with the devices of the system 100 via the networks 103, using the various device communication protocols (e.g., TCP/IP). In some embodiments, the client computer 106a, 106c comprises integrated client cameras 106b, 106d that capture and generate image data. Additionally or alternatively, in some embodiments, the client computer 106a, 106c comprises hardware components connecting to the client camera 106b, 106d. The client computer 106a, 106c receives image data from the client camera 106b, 106d, and transmits the image data to the image-processing server 102 via the one or more public or private networks 103.

The client device 106 may execute one or more software programs for accessing the services and features hosted by the management server 102 of the image processing system 101. The software of the client device 106 includes, for example, a web browser or locally installed software associated with the image processing system 101. The software allows the client device 106 to communicate with, operate, manage, or configure the features and functions of the image-processing server 102. In some embodiments, the client device 106 executes the design software or accesses the design software hosted by the image-processing server 102. The design software provides a design graphical user interface allowing the user to provide inputs for designing a particular object, which may be a real or imaginary object. The design software compiles or otherwise generates a computer file containing the user’s design containing the user-designed object. In some cases, the image-processing server 102 ingests the design file from a non-transitory storage memory (e.g., hard disk of the image-processing server 102, database 104). In some cases, the image-processing server 102 ingests the design file as transmitted by the client device 106.

FIG. 1B shows an example of a graphical user interface 112 of the software executed by the client device 106, presented to the user of the client device 106. The graphical user interface 112 allows the user to interact with the operations of the image-processing server 102 and/or the database 104, which includes managing and configuring the functions and data of the machine-learning architectures 109. The graphical user interface 112 shows examples of the input image data, as displayed and accessible to the user, which the client device 106 selects from a non-transitory storage (e.g., local storage of the client device 106, database 104) and transmits to the image-processing server 102. The input image data includes, for example, an input video recording 114 and/or input still images 116. In some cases, the client device 106 or image-processing server 102 generates the input still images 116 by parsing or generating snapshots of the input video recording 114. The input image data may include additional types of data associated with the input image data or used for training the machine-learning architecture 109, such as timestamps, data source identifiers (e.g., “stream” in FIG. 1B), and labels (“class” in FIG. 1B), among other types of data.

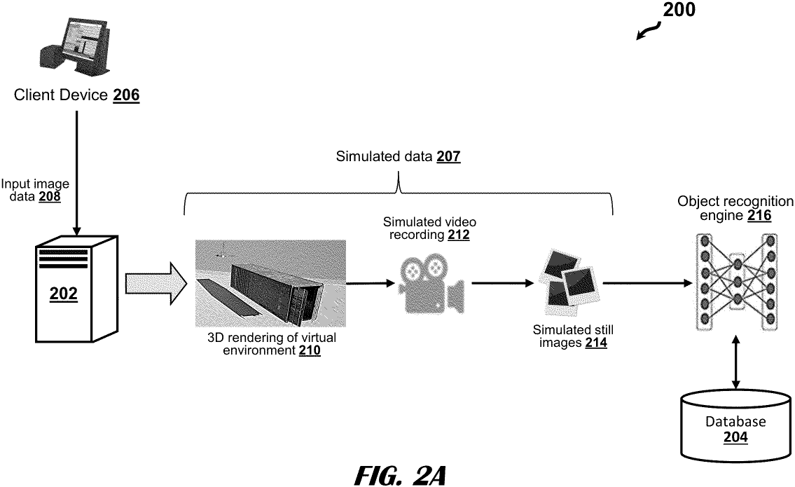

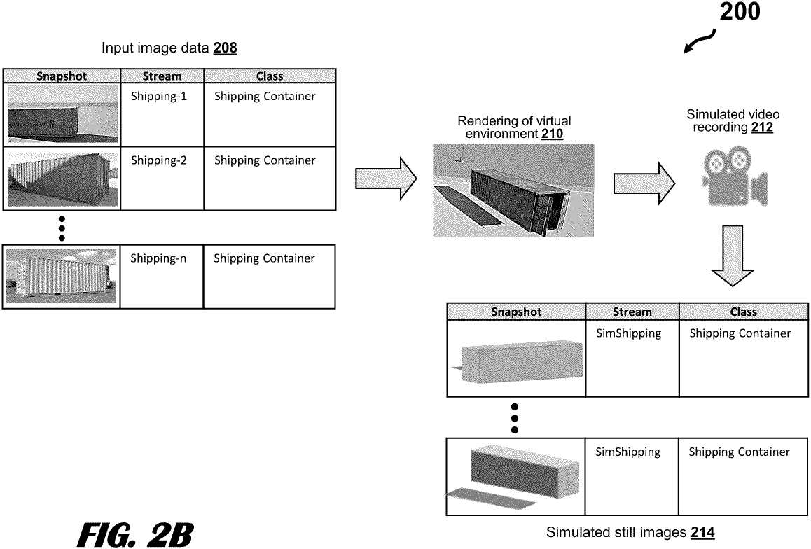

FIGS. 2A-2B show dataflow between components of a system 200 performing image-processing operations, including operations for ingesting and analyzing various types of input image data 208, and training or applying one or more machine-learning architectures on simulated data 207. A server 202 (or other computing device) uses the input image data 208 to generate the simulated data 207 containing a simulated object as a virtual representation of a target object in the input image data 208. The server 202 applies the object recognition engine 216 on the simulated data 207 having the simulated object to train the object recognition engine 216 to recognize the particular target object captured in the input image data 208.

A user operates the client device 206 to upload, design, or otherwise input the input image data 208 containing a target object to the server 202. The input image data 208 may include input video recordings, input still images, and various types of metadata or data, such as an indication of the target object. In some cases, the client device 206 or server 202 executes design software (e.g., CAD design software) for designing and generating a real or imagined target object. The user interacts with a graphical user interface of the design software to design the target object. The design software outputs a computer file containing the user-designed target object, which the server 202 receives or ingests as the input image data 208. In some cases, the input image data 208 includes input video recordings containing the target object. For instance, the input image data 208 may include snapshot images and/or video segments. In FIG. 2B, for example, the leftmost column (depicting examples of the input image data 208) may include raw video segments and/or still images or frames of video recordings. The server 202 may generate input still images parsed from the input image data 208. The input video recordings and input still images may contain imagery of any number of example instances of the target object. The example instances in the input image data 208 include variations in the target object captured, such as variations in the perspective angle, color, background environment, and other variable characteristics. For example, the input image data 208 includes any number of input still images of any number of shipping containers. The input image data 208 includes certain types of metadata, such as a data source (e.g., image file, data stream) and classification of the target object.

The server 202 generates various forms of simulated data 207 using the input image data 208, where the simulated data 207 includes various types of data containing a simulated object as a virtual representation of the target object. The simulated data 207 includes, for example, a three-dimensional rendering of a virtual environment 210 containing the simulated object; a video recording (referred to as a simulated recording 212) of multiple perspective angles of the simulated object situated in the virtual environment 210; and still images (referred to as simulated still image(s) 214) that the server 202 parsed from the simulated recording 212.

In some embodiments, the server 202 may generate the simulated virtual environment 210 to incorporate one or more types of “noise” being generated by the server 202. The automated generation of noise by the server 202 (or other computing device or data source) simulates flaws, errors, or other types of noise that potentially occurs in image data. The simulated noise may be a form of data augmentation operation that trains and produces a more robust machine-learning architecture by applying the object recognition engine 216 or other layers of the machine-learning architecture on the simulated data 207 that includes the simulated noise. Non-limiting examples of such “noise” that may be simulated includes occlusions on camera and additional similar objects within the environment, among other real-world types of constraints.

In operation, the server 202 executes software programming, which may include layers of the machine-learning architecture, for generating the virtual environment 210 containing the simulated object. The server 202 generates the simulated object and the virtual environment 210 using the input still images of the target object. For example, server 202 generates the virtual environment 210 containing a simulated shipping container based on the various shipping containers displayed by the input still images. In some implementations, the user may interact with the machine-generated virtual environment 210 to manage certain visual aspects of the virtual environment 210 imagery, such as configuring the lighting (e.g., amount of lighting, angle of lighting, shadows of the simulated object or environmental objects), configuring additional virtual objects in the virtual environment 210, and configuring the “physical” features of the simulated object (e.g., color, texture, damage), among other visual aspects of the virtual environment 210. In this way, the user can manipulate the virtual environment 210 or the simulated object to provide data augmentation benefits, by generating more variants or challenging instances of the simulated data 207 to train a more robust object recognition engine 216.

The server 202 may vary the light source location in many different positions and may also vary the proximity of the light source location to the object. The server 202 may vary the type of light source, such as the sun, street lights, lamps, etc. The server 202 may vary a number of light sources, such as including numerous street lights. When generating the virtual environment 210, in addition to generating the simulated light source and perspectives of the object situated in the virtual environment 210, the server 202 may further simulate a variety of distances from a virtual camera perspective or virtual field of view to the object as situated in the virtual environment 210.

In some implementations, the server 202 generates one or more simulated recordings 212 of the virtual environment 210 in a video file format. The server 202 programming may, for example, rotate the virtual environment 210 around the simulated object, shift the focal point of recording to different parts of the simulated object, and zoom closer to or further from the simulated object. For example, the server 202 rotates the virtual environment 210 around the simulated shipping container, and shifts the focal point from the frontend of the simulated shipping container, to the center of the simulated shipping container, to the backend of the simulated shipping container. The server 202 may generate the simulated recording 212 such that a viewer would experience the simulated recording 212 as a “fly over” or “fly around” of the simulated object and the virtual environment 210, capturing a large number of perspective angles of the simulated object. In some implementations, the server 202 may generate the simulated recordings 212 for the machine-generated virtual environment 210 and any variation of the virtual environment 210 as configured or edited by the user.

The image-processing server 102 generates a plurality of simulated still images 214 parsed or otherwise captured from the simulated recording 212. The simulated still images 214 need to also include various types of metadata associated with the still images 214, where the metadata may be generated or extracted by the server 202 prior to passing the still images 214 into the object recognition engine 216 (as discussed further below). The simulated still images 214 include a plurality of perspective angles around the simulated object, as parsed or captured from the simulated recording 212. For example, the server 202 generates a plurality of simulated still images 214 by parsing or capturing snapshots from the simulated recording 212 of the simulated shipping container in the virtual environment 210. The simulated still images 214 include a plurality of snapshots of the simulated shipping container, capturing a plurality of angles around the simulated shipping container in the virtual environment 210. The server 202 may generate the simulated still images 214 representing a full frame or a portion of the frame, and, in some implementations, may further generate associated metadata indicating individual object locations within a frame, boundaries of the external edge of the object, and optical flow (motion) of detected objects within the frame.

The server 202 then extracts image data features of each simulated still image 214 and applies the object recognition engine 216 on the extracted features. The object recognition engine 216 may include layers defining a classifier that generates predicted outputs (e.g., predicted object) by applying the object recognition engine 216 on the simulated still image 214 or, in some cases, other training still images containing the target image (e.g., input still images of the input image data 208). The database 204 stores the simulated still images 214 with training labels indicating certain expected outputs (e.g., expected objected) for the simulated still image 214 or other information about the simulated data 207 or simulated object. The server 202 determines a level of error between the predicted outputs generated by the object recognition engine 216 and the expected outputs indicated by the labels associated with the simulated still images 214. The machine-learning architecture executed by the server 202 executes various loss functions and/or optimization functions that adjust or tune various hyper-parameters or weights of the object recognition engine 216 to lower the level of error. The server 202 determines that the machine-learning architecture sufficiently trained the object recognition engine 216 to recognize the target object when the server 202 determines that the level of error satisfies a training threshold.

The server 202 stores the trained object recognition engine 216 into the database 204. The server 202 may reference and execute the object recognition engine 216 to recognize objects contained in future input image data 208 received from the client device 206 (or other data sources). The server 202 may generate a report or indication of the objects recognized by the object recognition engine 216 in the future input image data. In some implementations, the server 202 may store various types of data about known objects in the database 204, which the server 202 or the object recognition engine 216 references in later operations. Additionally or alternatively, the server 202 may implement the outputs (e.g., classifications, extracted features) generated by the trained object recognition engine 216 in various downstream operations, such as retraining or managing the object recognition engine 216, auditing the known objects previously recognized by or used to train the object recognition engine 216, among any number of downstream operations.

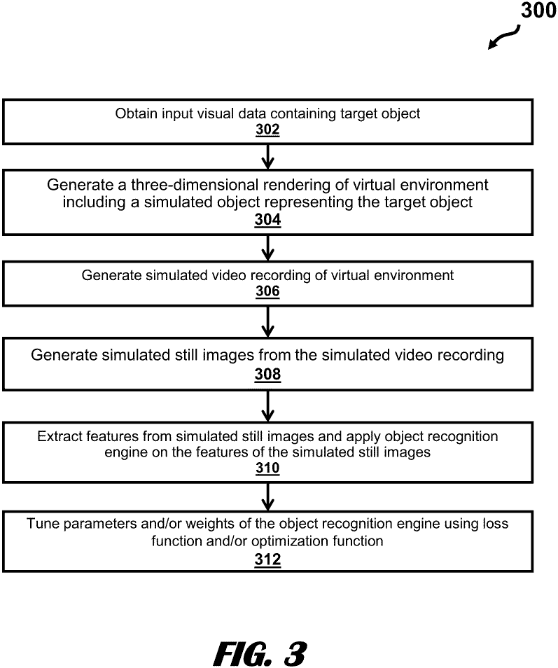

FIG. 3 shows steps of a method 300 for generating simulated image data for training an object recognition engine of a machine-learning architecture. A server (e.g., image-processing server 102) performs the steps of the method 300 by executing machine-readable software code installed on the server, though any type of computing device (e.g., desktop computer, laptop computer) or any number of computing devices and/or processors may perform the various operations of the method 300. Moreover, embodiments may include additional, fewer, or different operations than those described in the method 300.

In step 302, the server obtains input image data containing a target object for training the object recognition engine. The input image data may include a continuous video recording, still images, or a user-generated design. The server obtains the input image data in the form of a computer file or continuous data feed. The server may receive the input image data from any number of data sources, such as a corpus of image data stored in a database, and client devices or cameras uploading or transmitting the input image data to the server, among others. The input image data may include data or metadata used for training labels, which indicate, for example, the one or more target objects in the input image data. In some cases, a user may input the data for the training labels.

The input image data includes any number of input still images including the target object. Where the input image data includes an input video recording, the server generates input still images parsed or captured as snapshots from portions of the input video recording. Using the input still images including the target object, the server performs operations to generate various types of simulated data including a simulated object as a virtual representation of the target object (as in steps 304-308).

In step 304, the server generates the simulated data comprising a three-dimensional rendering of a virtual environment including the simulated object representing the target object. The server executes various operations, which may include functions of the machine-learning architecture, to generate the simulated object and the virtual environment using the input still images. In some implementations, the user may configure visual aspects of the three-dimensional rendering or of additional three-dimensional renderings. For instance, the user may configure the visual aspects of the virtual environment (e.g., background objects, lighting, shadows) or the visual aspects of the simulated object (e.g., color, texture, damage, signage).

In step 306, generates a simulated video recording as a video file capturing various perspective angles of the simulated image and the virtual environment. The server generates simulated recordings for the particular virtual environment and, in some cases, for any variation of the virtual environment configured or edited by the user (as in step 304). The server generates the simulated recording such that the user views the simulated recording as a “fly over” or “fly around” of the simulated object and the virtual environment, where the simulated recording captures a large number of perspective angles of the simulated object. The server may, for example, rotate the virtual environment around the simulated object, shift the focal point of recording to different parts of the simulated object, and zoom closer to or further from the simulated object.

In step 308, the server generates simulated still images from the simulated video recording. To generate the simulated still images, the server may parse or capture video frame snapshots from the simulated video recording. The simulated still images include any number of angles of the simulated object as situated in the virtual environment.

In step 310, the server extracts image data features from each of the simulated still images and applies the object recognition engine on the simulated still images. In step 312, the server tunes parameters and/or weights of the object recognition engine by executing a loss function and/or optimization function to train the object recognition engine. The server references the training labels associated with each of the simulated still images, indicating the expected outputs (e.g., expected object) that a classifier of the object recognition engine should output when applied to the particular still image. When the server applies the object recognition engine to the simulated still images, the object recognition engine generates predicted outputs for the simulated still images. The server evaluates the level or rate of error between the predicted outputs generated for the simulated still images and the expected outputs indicated by the training labels for the simulated still images. The loss functions or optimization functions may tune or adjust the hyper-parameters or weights of the object recognition engine to lower the level of error. The server sufficiently trained the object recognition engine when the level of error satisfies a training threshold. The server may store the trained object recognition engine into a database for downstream operations or for distribution to various client devices for execution.

In some embodiments, a computer-implemented method comprises receiving, by a computer, input image data for a target object, the input image data including one or more visual representations of the input object at a plurality of angles of the target object; generating, by the computer, a three-dimensional rendering of a virtual environment including a simulated object representing the target object situated in the virtual environment; generating, by the computer, a plurality of simulated still images for the simulated object, the plurality of simulated still images including the simulated object at a plurality of angles of the simulated object; applying, by the computer, a machine-learning architecture on the plurality of simulated still images to generate a predicted object for each particular simulated still image; and determining, by the computer, a level of error for the machine-learning architecture based upon the predicted object for each particular simulated still image and an expected object indicated by a training label associated with the particular still image. In response to the computer determining that the level of error fails to satisfy a training threshold: updating, by the computer, one or more parameters of the machine-learning architecture based upon the predicted object for each particular simulated still image and using an expected object associated with the particular still image.

In some implementations, the method further comprises storing, by the computer, the machine-learning architecture into a machine-readable memory responsive to determining that the level of error satisfies the training threshold.

In some implementations, determining the predicted object includes extracting, by the computer, a first set of image data features for the simulated object from each simulated still image; generating, by the computer, an object recognition score for the simulated object indicating one or more similarities between the image data features for the simulated object a second set of image data features for the target object; and identifying, by the computer, the simulated object as the predicted object when the object recognition score for the simulated object satisfies an object recognition threshold.

In some implementations, generating the simulated data further includes generating, by the computer, a plurality of snapshots of the simulated object situated in the virtual environment.

In some implementations, generating the simulated data further includes generating, by the computer, a simulated video recording of the simulated object situated in the virtual environment by rotating the three-dimensional rendering about the simulated object. The computer generates the plurality of simulated still images from the simulated video recording having the simulated object.

In some implementations, generating the simulated data further includes parsing, by the computer, the simulated data into the plurality of simulated still images including a plurality of representations of the simulated object for a plurality of angles of the simulated object.

In some implementations, the three-dimensional rendering of the virtual environment includes a simulated light source. The computer generates each simulated still image according to the simulated light source relative to a perspective angle of the simulated object.

In some implementations, the input image data includes at least one of a video recording or a still image.

In some implementations, receiving the input image data for the target object includes generating, by the computer, a plurality of input still images parsed from an input video recording. The computer generates the rendering of the virtual environment based upon the plurality of still images.

In some implementations, the computer receives the input image data via design software having a designer user interface for generating the input image data based upon design inputs received from the designer user interface.

In some embodiments, a system comprises a non-transitory machine-readable storage memory configured to store executable instructions; and a computer comprising a processor coupled to the storage memory and configured, when executing the instructions, to: receive input image data for a target object, the input image data including one or more visual representations of the input object at a plurality of angles of the target object; generate a three-dimensional rendering of a virtual environment including a simulated obj ect representing the target object situated in the virtual environment; generate a plurality of simulated still images for the simulated object, the plurality of simulated still images including the simulated object at a plurality of angles of the simulated object; apply a machine-learning architecture on the plurality of simulated still images to generate a predicted object for each particular simulated still image; and determine a level of error for the machine-learning architecture based upon the predicted object for each particular simulated still image and an expected object indicated by a training label associated with the particular still image. In response to the computer determining that the level of error fails to satisfy a training threshold: update one or more parameters of the machine-learning architecture based upon the predicted object for each particular simulated still image and using an expected object associated with the particular still image.

In some implementations, the computer is further configured to store the machine-learning architecture into the machine-readable memory responsive to the computer determining that the level of error satisfies the training threshold.

In some implementations, when determining the predicted object, the computer is further configured to extract a first set of image data features for the simulated object from each simulated still image; generate an object recognition score for the simulated object indicating one or more similarities between the image data features for the simulated object a second set of image data features for the target object; and identify the simulated object as the predicted object when the object recognition score for the simulated object satisfies an object recognition threshold.

In some implementations, when generating the simulated data, the computer is further configured to generate a plurality of snapshots of the simulated object situated in the virtual environment.

In some implementations, when generating the simulated data, the computer is further configured to generate a simulated video recording of the simulated object situated in the virtual environment by rotating the three-dimensional rendering about the simulated object. The computer generates the plurality of simulated still images from the simulated video recording having the simulated object.

In some implementations, when generating the simulated data, the computer is further configured to parse the simulated data into the plurality of simulated still images including a plurality of representations of the simulated object for a plurality of angles of the simulated obj ect.

In some implementations, the three-dimensional rendering of the virtual environment includes a simulated light source, and wherein the computer is configured to generate each simulated still image according to the simulated light source relative to a perspective angle of the simulated object.

In some implementations, the input image data includes at least one of a video recording or a still image.

In some implementations, when receiving the input image data for the target object, the computer is further configured to generate a plurality of input still images parsed from an input video recording. The computer generates the rendering of the virtual environment based upon the plurality of still images.

In some implementations, the computer receives the input image data via design software having a designer user interface for generating the input image data based upon design inputs received from the designer user interface.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method comprising:
receiving, by a computer, input image data for a target object, the input image data including one or more visual representations of the input object at a plurality of angles of the target obj ect;
generating, by the computer, a three-dimensional rendering of a virtual environment including a simulated object representing the target object situated in the virtual environment;
generating, by the computer, a plurality of simulated still images for the simulated object, the plurality of simulated still images including the simulated object at a plurality of angles of the simulated object;
applying, by the computer, a machine-learning architecture on the plurality of simulated still images to generate a predicted object for each particular simulated still image;
determining, by the computer, a level of error for the machine-learning architecture based upon the predicted object for each particular simulated still image and an expected object indicated by a training label associated with the particular still image; and
in response to determining that the level of error fails to satisfy a training threshold:
updating, by the computer, one or more parameters of the machine-learning architecture based upon the predicted object for each particular simulated still image and using an expected object associated with the particular still image.

2. The method according to claim 1, further comprising storing, by the computer, the machine-learning architecture into a machine-readable memory responsive to determining that the level of error satisfies the training threshold.

3. The method according to claim 1, wherein determining the predicted object includes:
extracting, by the computer, a first set of image data features for the simulated object from each simulated still image;
generating, by the computer, an object recognition score for the simulated object indicating one or more similarities between the image data features for the simulated object a second set of image data features for the target object; and
identifying, by the computer, the simulated object as the predicted object when the object recognition score for the simulated object satisfies an object recognition threshold.

4. The method according to claim 1, wherein generating the simulated data further includes generating, by the computer, a plurality of snapshots of the simulated object situated in the virtual environment.

5. The method according to claim 1, wherein generating the simulated data further includes generating, by the computer, a simulated video recording of the simulated object situated in the virtual environment by rotating the three-dimensional rendering about the simulated object, wherein the computer generates the plurality of simulated still images from the simulated video recording having the simulated object.

6. The method according to claim 5, wherein generating the simulated data further includes parsing, by the computer, the simulated data into the plurality of simulated still images including a plurality of representations of the simulated object for a plurality of angles of the simulated obj ect.

7. The method according to claim 1, wherein the three-dimensional rendering of the virtual environment includes a simulated light source, and wherein the computer generates each simulated still image according to the simulated light source relative to a perspective angle of the simulated obj ect.

8. The method according to claim 1, wherein the input image data includes at least one of a video recording or a still image.

9. The method according to claim 1, wherein receiving the input image data for the target object includes generating, by the computer, a plurality of input still images parsed from an input video recording, wherein the computer generates the rendering of the virtual environment based upon the plurality of still images.

10. The method according to claim 1, wherein the computer receives the input image data via design software having a designer user interface for generating the input image data based upon design inputs received from the designer user interface.

11. A system comprising:
a non-transitory machine-readable storage memory configured to store executable instructions; and
a computer comprising a processor coupled to the storage memory and configured, when executing the instructions, to:
receive input image data for a target object, the input image data including one or more visual representations of the input object at a plurality of angles of the target object;
generate a three-dimensional rendering of a virtual environment including a simulated object representing the target object situated in the virtual environment;
generate a plurality of simulated still images for the simulated object, the plurality of simulated still images including the simulated object at a plurality of angles of the simulated obj ect;
apply a machine-learning architecture on the plurality of simulated still images to generate a predicted object for each particular simulated still image;
determine a level of error for the machine-learning architecture based upon the predicted object for each particular simulated still image and an expected object indicated by a training label associated with the particular still image; and
in response to determining that the level of error fails to satisfy a training threshold:
update one or more parameters of the machine-learning architecture based upon the predicted object for each particular simulated still image and using an expected object associated with the particular still image.

12. The system according to claim 11, wherein the computer is further configured to store the machine-learning architecture into the machine-readable memory responsive to the computer determining that the level of error satisfies the training threshold.

13. The system according to claim 11, wherein, when determining the predicted object, the computer is further configured to:
extract a first set of image data features for the simulated object from each simulated still image;
generate an object recognition score for the simulated object indicating one or more similarities between the image data features for the simulated object a second set of image data features for the target object; and
identify the simulated object as the predicted object when the object recognition score for the simulated object satisfies an object recognition threshold.

14. The system according to claim 11, wherein, when generating the simulated data, the computer is further configured to generate a plurality of snapshots of the simulated object situated in the virtual environment.

15. The system according to claim 11, wherein, when generating the simulated data, the computer is further configured to generate a simulated video recording of the simulated object situated in the virtual environment by rotating the three-dimensional rendering about the simulated object, and wherein the computer generates the plurality of simulated still images from the simulated video recording having the simulated object.

16. The system according to claim 15, wherein, when generating the simulated data, the computer is further configured to parse the simulated data into the plurality of simulated still images including a plurality of representations of the simulated object for a plurality of angles of the simulated object.

17. The system according to claim 11, wherein the three-dimensional rendering of the virtual environment includes a simulated light source, and wherein the computer is configured to generate each simulated still image according to the simulated light source relative to a perspective angle of the simulated object.

18. The system according to claim 11, wherein the input image data includes at least one of a video recording or a still image.

19. The system according to claim 11, wherein, when receiving the input image data for the target object, the computer is further configured to generate a plurality of input still images parsed from an input video recording, and wherein the computer generates the rendering of the virtual environment based upon the plurality of still images.

20. The system according to claim 11, wherein the computer receives the input image data via design software having a designer user interface for generating the input image data based upon design inputs received from the designer user interface.
